(19) United States
(12) Patent Application Publication
(10) Pub. No.: US 2004/0109684 A1
(43) Pub. Date: Jun. 10, 2004

(54) Bidirectional wavelength division multiplexing self-healing ring network

(76) Inventors: Young-Hun Joo, Suwon-shi (KR); Yun-Je Oh, Yongin-shi (KR); Seong-Taek Hwang, Pyongtaek-shi (KR); Lae-Kyoung Kim, Suwon-shi (KR)

Correspondence Address: CHA & REITER, LLC, 210 ROUTE 4 EAST STE 103, PARAMUS, NJ, 07652, US

(21) Appl. No.: 10/464,047

(22) Filed: Jun. 17, 2003

(30) Foreign Application Priority Data
Dec. 6, 2002 (KR) 2002-77169

(51) Int. Cl. G02F 1/00; H04J 14/02

(52) U.S. Cl. 398/7; 398/83

(57) ABSTRACT

A bi-directional wavelength division multiplexing self-healing optical network is disclosed that is constructed of a bi-directional self-healing optical network with one strand of optical fiber which uses a wavelength switching bi-directional add/drop multiplexing unit. The bi-directional wavelength division multiplexing self-healing optical network includes a plurality of nodes. Each of the nodes include a wavelength switching bi-directional add/drop multiplexing section and a switching section for sensing whether at least one optical signal, which is received from a plurality of odd- and even-numbered channel pairs, exists, and for switching such an optical signal to at least one failure-free channel. This allows the optical signals to be transmitted through pairs of failure-free channels when a failure, such as breakage of the optical fiber, takes place. The network causes the same data to be carried on each odd- and even-numbered channel of a pair of channels, separates and transmits the carried data in opposite directions within a single optical fiber between each node. A check is performed to determine whether data to be transmitted exists in order to perform switching.

### CLAIM OF PRIORITY

This application claims priority to an application entitled “Bidrectional Wavelength Division Multiplexing Self-Healing Ring Network,” filed in the Korean Intellectual Property Office on Dec. 6, 2002 and assigned Serial No. 2002-77169, the contents of which are hereby incorporated by reference.

### BACKGROUND OF THE INVENTION

1. Field of the Invention

The present invention relates to a bi-directional wavelength division multiplexing self-healing optical network, in particular, a system capable of constructing a bi-directional self-healing optical network with one strand of optical fiber using a wavelength switching bi-directional add/drop multiplexing unit.

2. Description of the Related Art

Wavelength division multiplexing (WDM) optical transmission systems are adapted to perform transmission using various wavelengths in a single optical fiber. Such optical transmission systems are thus capable of improving transmission efficiency. In addition, such optical transmission systems are capable of transmitting optical signals regardless of the transmission speed. For these reasons, such optical transmission systems are used in very high-speed Internet networks, which must meet with the challenge of ever increasing transmission volume.

With the exponential growth in transmission speed of communication networks, the reliability of the communication networks is another important factor to consider. Accordingly, if such high-speed communication systems incur a failure, it has to exert a self-healing function to insure continuous service.

For example, an optical ring network is designed to set two different paths between two nodes. This allows for flexibility address a failure in one path. On the other hand, a self-healing optical ring network is designed to provide additional bandwidth or communication equipment to automatically restore a failure generated in the network.

Such optical ring networks are also divided by a traffic direction and a failure restoration technique. First, according to the traffic direction, optical ring networks are divided into unidirectional optical ring networks in which traffic is transmitted only in one direction and bi-directional optical ring networks in which traffic is transmitted in two opposite directions. In addition, according to the failure restoration technique, networks are divided into path-switched optical ring networks and line-switched optical ring networks.

An example of conventional WDM optical transmission networks with a self-healing function and using two strands of optical fiber, include a unidirectional optical ring network is a two-fiber WDM Unidirectional Path Switched Ring (UPSR), and an example of a bi-directional optical ring network is a two-fiber WDM Bi-directional Line Switched Ring (BLSR).

FIGS. 1a and 1b show schematic configurations of a two-fiber WDM UPSR. In particular, FIG. 1a shows a normal state, while FIG. 1b shows an abnormal state.

As shown in FIGS. 1a and 1b, the WDM UPSR is designed so that one of its two strands of optical fiber is allocated as a working fiber, while the other is allocated as a protection fiber. In a transmitting section, the same optical signals are split by a splitter 1, and then transmitted to the working fiber and the protection fiber. In a receiving section, optical signals are selected and received through an optical switch 2. In a normal state operation, optical signals are received through the working fiber (FIG. 1a), but when a failure occurs, the optical switch of the receiving section is switched, and then optical signals are received through a protection fiber (FIG. 1b). Such WDM UPSR has a relatively simple construction and can be used without changing initial allocated paths even in a failure state.

However, in such WDM UPSR, the working fiber has to share the same nodes as the protection fiber. Moreover, the nodes of the protection fiber are used only in an abnormal state (i.e., not used in a normal state), which increases the cost for the nodes.

FIGS. 2a and 2b show schematic configurations of a two-fiber WDM BLSR. In particular, FIG. 2a shows a normal state, while FIG. 2b shows an abnormal state.

As shown in FIGS. 2a and 2b, the WDM BLSR is designed so that in a Dense Wavelength Division Multiplexing (DWDM), a single optical fiber is allocated as neither a working fiber nor a protection fiber. In contrast, one half of the total wavelengths propagated in the single optical fiber are allocated as working wavelengths assigned to data having a higher quality of service, and the other half is allocated as protection wavelengths assigned to data having a lower quality of service. In a failure state, only wavelengths allocated as working wavelengths are used to restore the network, but wavelengths allocated as protection wavelengths are not used. Since the WDM BLSR allows all the nodes shared with two strands of optical fiber to be available in a normal state, the node availability is high.

However, in such WDM BLSR systems, optical signals that cannot travel to a target destination, due to a broken path when a failure takes place, are turned back toward the target destination (i.e., in the direction opposite to the original traveling direction). To maintain optical signal quality during a failure, the number of paths for optical wavelengths allocated in a normal state may be increased.

It should also be appreciated that a WDM UPSR or WDM BLSR requires at least two strands of optical fiber. When N number of channels pass through the optical fiber in the normal state, the number of channels applied to an amplifier of each node in the abnormal state fall to a range from 0 (zero) to N. Therefore, according to the input power of the amplifier, the controlling region becomes broad.

FIG. 3 shows how a plurality of channels are input into each node when a failure takes place in a WDM UPSR with six channels. In this example, the WDM UPSR includes of four nodes. When communication is carried out with six channels between the four nodes, an amplifier associated with each node in a normal state is supplied with a constant power for the six channels. However, when a failure of the optical fiber takes place, no channel is input into the nodes nearest to the failure position. Therefore, channels between 0 and 6 are input into each node, which requires that each amplifier must be able to cope with various input powers.

Accordingly, there is a need in the art for improved bi-directional wavelength division multiplexing self-healing optical networks.

### SUMMARY OF THE INVENTION

Accordingly, one object of the present invention is to solve the above-mentioned problems occurring in the prior art.

Another object of the present invention is to provide a bi-directional wavelength division multiplexing self-healing optical network capable of reducing expenses necessary to construct nodes as well as increasing availability of an optical fiber, by constructing a bi-directional self-healing optical network with one strand of optical fiber.

Yet another object of the present invention to provide a bi-directional wavelength division multiplexing self-healing optical network capable of reducing a controlling region according to input power of an optical amplifier of each node by decreasing a difference in the number of channels inputted into the optical amplifier.

One embodiment of the present invention is directed to a bi-directional wavelength division multiplexing self-healing optical network, in which a plurality of nodes are connected with each other through an optical fiber. Each of the nodes includes a transmitting section for outputting a plurality of channels of different wavelengths and for transmitting the same transmission data on a plurality of pairs of channels. Each pair of channels includes an odd-numbered channel for one channel and an even-numbered channel for the other channel. The network also includes a wavelength switching bi-directional add/drop multiplexing section including first to fourth inter-leavers. Each of the inter-leavers is provided with first to third terminals that allow for transmitting optical signals in both directions. Each of the inter-leavers have the second and third terminals connected with each other by means of one strand of optical fiber, causing the odd-numbered channels and the even-numbered channels, which the plurality of pairs of channels carrying the same transmission data are comprised of, to be forwarded in a direction opposite to each other, causing both the odd-numbered channels and the even-numbered channels forwarded in opposite directions to be forwarded in the same direction through the first terminal, and inter-leavering the odd numbered channels and the even-numbered channels forwarded in the same direction. The network also including an add/drop multiplexing unit for demultiplexing the channels in order to drop at least one, which is to be received, of the optical signals inter-leavered with the odd- and even-numbered channels by the second inter-leaver, and for multiplexing at least one, which is to be transmitted, of the optical signals inter-leavered with the odd- and even-numbered channels by the second inter-leaver; a switching section for sensing whether or not at least one optical signal to be received from a plurality of odd- and even-numbered channel pairs which have been demultiplexed and dropped exists and for switching such an optical signal to at least one failure-free channel, and a receiving section for receiving at least one optical signal from the switched channel.

### BRIEF DESCRIPTION OF THE DRAWINGS

The above features and advantages of the present invention will be more apparent from the following detailed description taken in conjunction with the accompanying drawings, in which:

FIGS. 1a and 1b show schematic configurations of a two-fiber WDM UPSR;

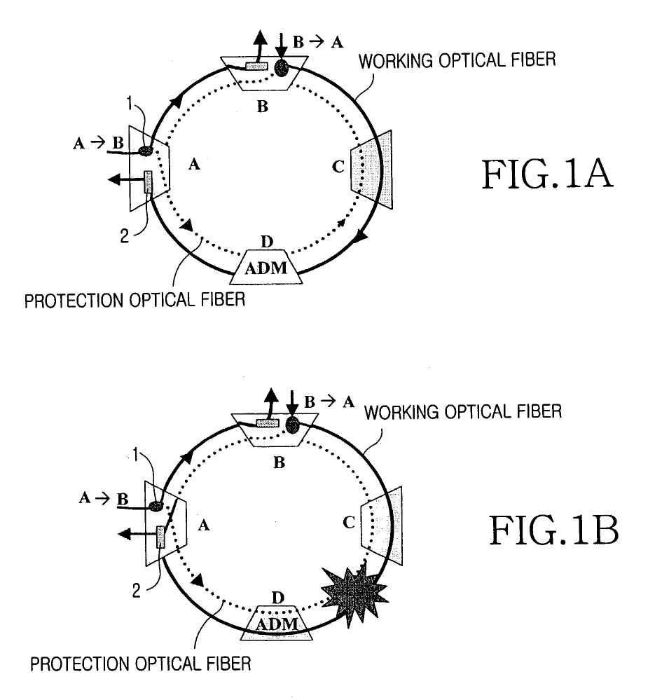

FIGS. 2a and 2b show schematic configurations of a two-fiber WDM BLSR;

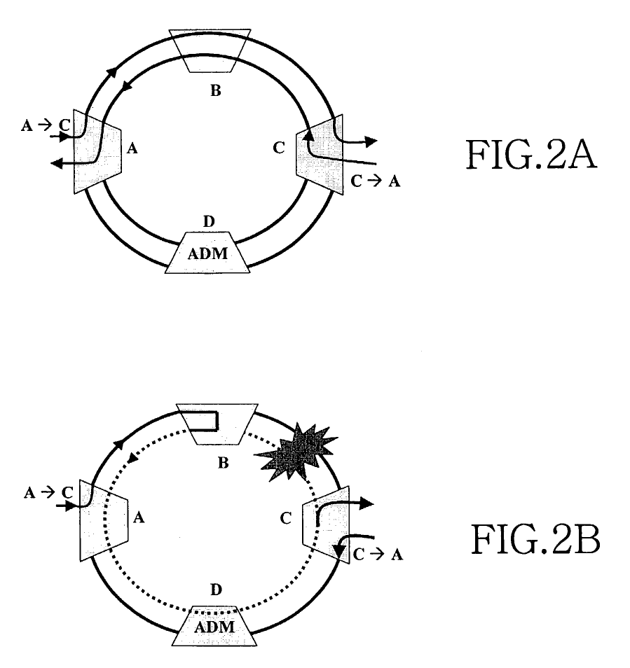

FIG. 3 shows how a plurality of channels are input into each node when a failure takes place in a WDM UPSR with six channels;

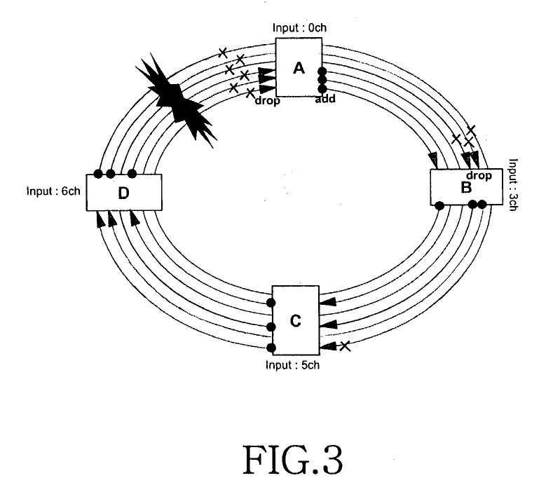

FIG. 4 shows a configuration of one of a plurality of nodes applied to a bi-directional wavelength division multiplexing self-healing optical network according to one embodiment of the present invention;

FIG. 5 shows the operation of one of a plurality of inter-leavers that are applied in accordance with aspects of the present invention;

FIG. 6 shows a configuration of a bi-directional wavelength division multiplexing self-healing optical network in a normal state, which is implemented with four nodes using the configuration of the node shown in FIG. 4;

FIG. 7 shows a configuration of a bi-directional wavelength division multiplexing self-healing optical network in a failure state, which is implemented with four nodes using the configuration of the node shown in FIG. 4; and

FIG. 8 shows how a plurality of channels are input into each node when a failure takes place in a bi-directional wavelength division multiplexing self-healing optical network in accordance with aspects of the present invention, in which communication is carried out with eight channels between four nodes.

### DETAILED DESCRIPTION OF THE PREFERRED EMBODIMENT

Hereinafter, a preferred embodiment of the present invention will be described in detail with reference to the accompanying drawings. For the purposes of clarity and simplicity, a detailed description of known functions and configurations incorporated herein will be omitted as it may obscure the subject matter of the present invention.

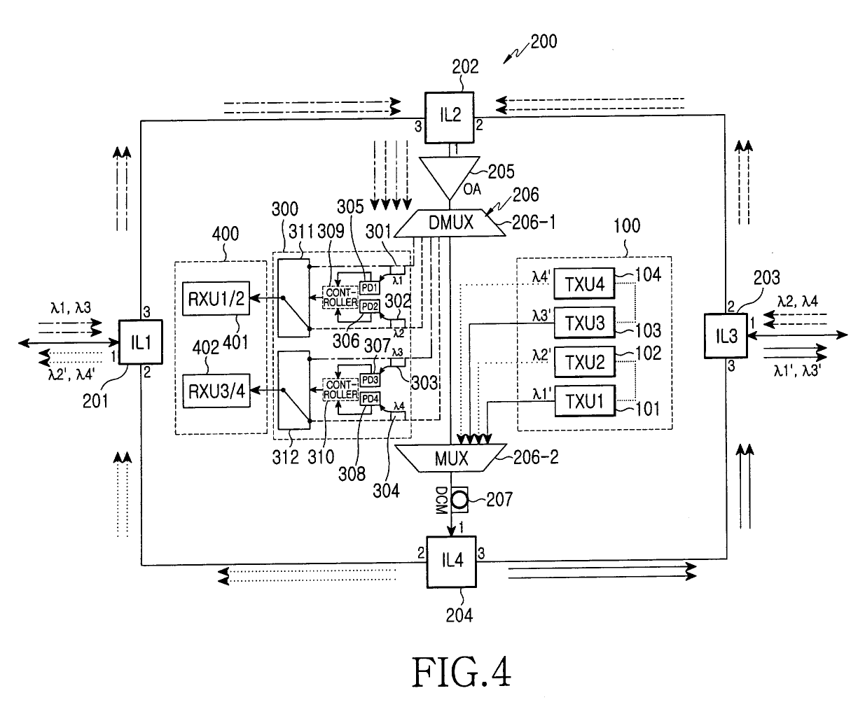

FIG. 4 shows a configuration of any one of a plurality of nodes applied to a bi-directional wavelength division multiplexing self-healing optical network according to one embodiment of the present invention. Each of the nodes includes a transmitting section 100 for modulating the same transmission data onto a plurality of pair of odd- and even-numbered channels and a wavelength switching bi-directional add/drop multiplexing section 200 for causing the odd-numbered channels and the even-numbered channels to travel in a direction opposite to each other, inter-leavering alternately the odd-numbered channels and the even-numbered channels to be combined into a single optical signal, demultiplexing to drop one or more optical signal which is to be received, and multiplexing to add one or more optical signal which is to be transmitted. The node also includes a switching section 300 for sensing whether or not at least one receivable signal exists and for then converting a forwarding direction of the sensed receivable signal into another failure-free direction and a receiving section 400 for receiving a switched receivable signal. In the present embodiment, description will be made regarding construction for receiving two channels of λ2 and λ4, but it will be apparent that it is possible to expand the construction for receiving N number of channels. Further, a bi-directional add/drop multiplexing unit is disclosed in detail in Korean Patent Application No. 2002-0027146, entitled “wavelength switching bi-directional add/drop multiplexing unit” and filed on May 16, 2002. For this reason, the bi-directional add/drop multiplexing unit will not be described in detail below.

The transmitting section 100 includes a plurality of optical transmitters 101 to 104 that output different channels of different wavelengths λ1, λ2, λ3 and λ4. Of the channels, adjacent pairs of odd and even channels, for example λ1 and λ2, carry the same data.

The wavelength switching bi-directional add/drop multiplexing section 200 includes a bi-directional add/drop multiplexing unit 206 including four inter-leavers 201 to 204, an optical amplifier 205, a demultiplexer 206-1 and a multiplexer 206-2, and a dispersion-compensating module 207.

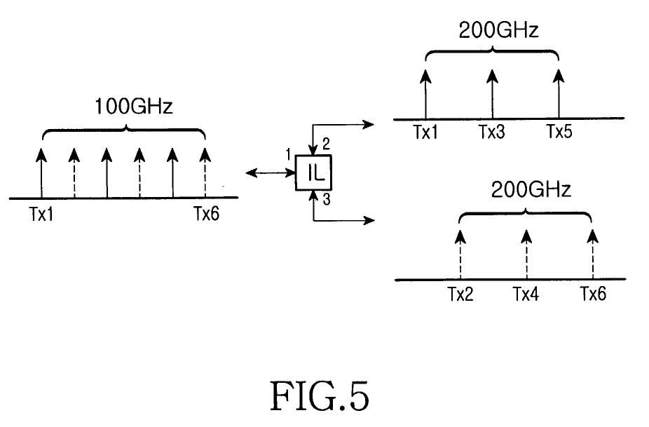

Referring to FIG. 5, wavelength division multiplexed optical signals are input into a number 1 terminal of the inter leavers 201 to 204, even-numbered channels are outputted to a number 2 terminal, while odd-numbered channels are outputted to a number 3 terminal. It is noted that both even-numbered channels input into the number 2 terminal and odd-numbered channels input into the number 3 terminal are output to the number 3 terminal.

The optical amplifier 205 amplifies and outputs input optical signals. The optical amplifier 205 may make use of a unidirectional optical amplifier, such as an Er-doped optical amplifier, a Pr-doped optical amplifier, a semiconductor laser amplifier and so forth.

The bi-directional add/drop multiplexing unit 206 includes a 1×N demultiplexer 206-1 and an N×1 multiplexer 206-1. This unit performs a demultiplexing function to drop receivable signals and a multiplexing function to add transmittable signals.

The dispersion-compensating module 207 compensates for chromatic dispersion generated from an optical fiber through which optical signals are transmitted during a high-speed transmission. Examples of a dispersion-compensating module are a chromatic dispersion-compensating fiber or a fiber grating.

The switching section 300 includes four 10/90 couplers 301 to 304, four photodiodes 305 to 308, two controllers 309 and 310, and two 1×2 optical switches 311 and 312.

The 10/90 couplers 301 to 304 branch off receivable optical signals to check whether receivable optical signals exist.

The photodiodes 305 to 308 sense intensities of the branched optical signals and then transmit the sensed results.

The controllers 309 and 310 check whether optical signals exist according to light intensities sensed from the photodiodes to control the optical switches.

The 1×2 optical switches 311 and 312 carry out the switching of failure channels into failure-free channels by means of the controllers 309 and 310.

The receiving section 400 includes two optical receivers 401 and 402, and receives the switched failure-free channels or optical signals.

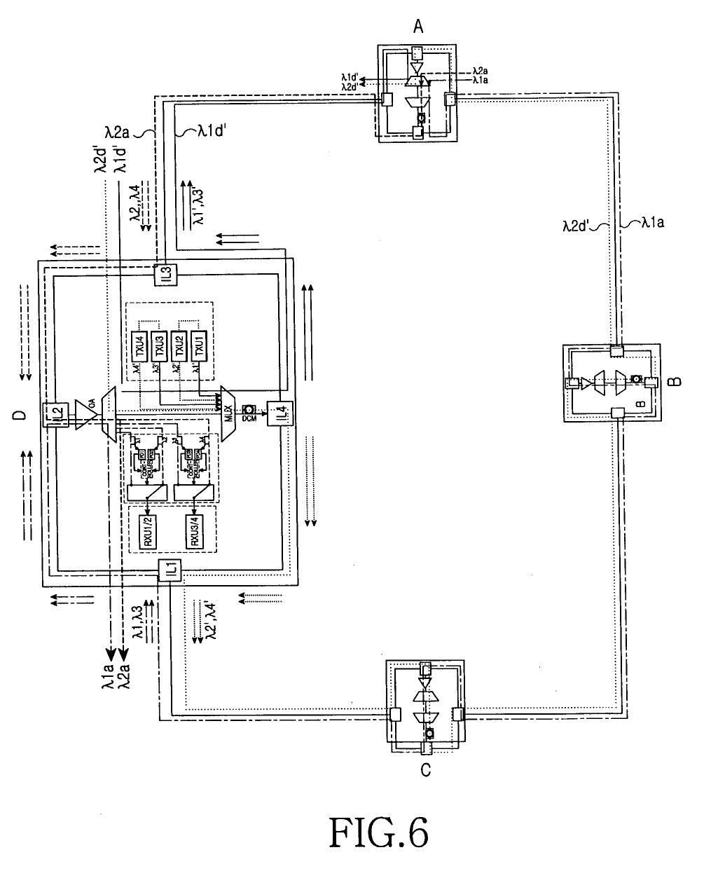

FIG. 6 shows a configuration of a bi-directional wavelength division multiplexing self-healing optical network in a normal state, which is implemented with four nodes using the configuration of the node shown in FIG. 4. Here, all four nodes have the same configuration and only one of the nodes (i.e., node D) is shown for the sake of convenience.

FIG. 6 depicts communication between nodes A and D. In node A, identical data are modulated onto each of the channels λ1, λ2, λ3 and λ4. The λ1 and λ3 channels are transmitted in the clockwise direction, while the λ2 and λ4 channels are transmitted in the counterclockwise direction. In node D, at least one appropriate channel is selected from among the transmitted channels. In node D, identical data is carried on each of the channels λ1′, λ2′, λ3′ and λ4′. The λ1′ and λ3′ channels are transmitted in the clockwise direction, while the λ2′ and λ4′ channels are transmitted in the counterclockwise direction. In node A, at least one appropriate channel is selected from among the transmitted channels.

Referring now to FIGS. 4 and 6, the operation of node D will be described. Identical data is carried on the λ1′ channel of a TXU1 and a first transmitter 101, on the λ2′ channel of a TXU2 and a second transmitter 102, on the λ3′ channel of a TXU3 and a third transmitter 103, and on the λ4′ channel of a TXU4 and a fourth transmitter 104. Of the carried channels, an odd-numbered channels, the λ1′ and λ3′ channels are transmitted in the clockwise direction, while even-numbered channels, the λ2′ and λ4′ channels are transmitted in the counterclockwise direction. The λ1 and λ3 channels input from the A node are input through an IL1, a first inter-leaver 201, into an IL2, a second inter-leaver 202, while the λ2 and λ4 channels are input through an IL3, a third inter-leaver 203, into the IL2. In the IL2, the optical signals, which are input into each of the number 2 and 3 terminals in a direction opposite to each other, are subjected to inter-leavering—performing allocation in a manner to alternate the odd-numbered channels and the even-numbered channels with each other and to make the interval between adjacent channels narrow—to be combined into a single optical signal, which then are output to number 1 terminal. The combined single optical signal is amplified by the optical amplifier 205, and separated into discrete wavelengths by the demultiplexer 206-1 of the bi-directional add/drop multiplexing unit 206. Optical signals, i.e., the λ1, λ2, λ3 and λ4 channels, which are to be transmitted at a target node are dropped. The dropped individual optical signals are branched off at the 10/90 couplers 301 to 304. Intensities of optical signals branched by the photodiodes 305 to 308 are sensed. The controllers 309 and 310 check whether optical signals exist according to the intensity of optical signals and then to cause the optical switches 311 and 312 to switch them into failure-free channels. In a normal state, the λ2 and λ4 channels, which are input along the closest path, are input into the RXU1 401 and the RXU2 402. The other unreceived signals, i.e., the λ1 and λ3 channels and the newly added λ1′, λ2′, λ3′ and λ4′ channels, are multiplexed again by the multiplexer 206-2 of the bi-directional add/drop multiplexing unit 206. The multiplexed optical signals, which generate a chromatic dispersion during a high-speed transmission, are compensated by the dispersion compensating module 207, and are input into the number 1 terminal of the IL4, the fourth inter-leaver 204. As a result, odd-numbered channels are output to the number 3 terminal or the right-hand path of the IL4 and then input into the IL3, the third inter-leaver 203. The even-numbered channels are output to the number 2 terminal or the left-hand path of the IL4 and then input into the IL1, the first inter-leaver 201. Either the odd-numbered channels input into IL1 or the even-numbered channels input into IL3 are directed to a target node. For instance, the λ1′ and λ3′ channels may be received at the node A along the closest path.

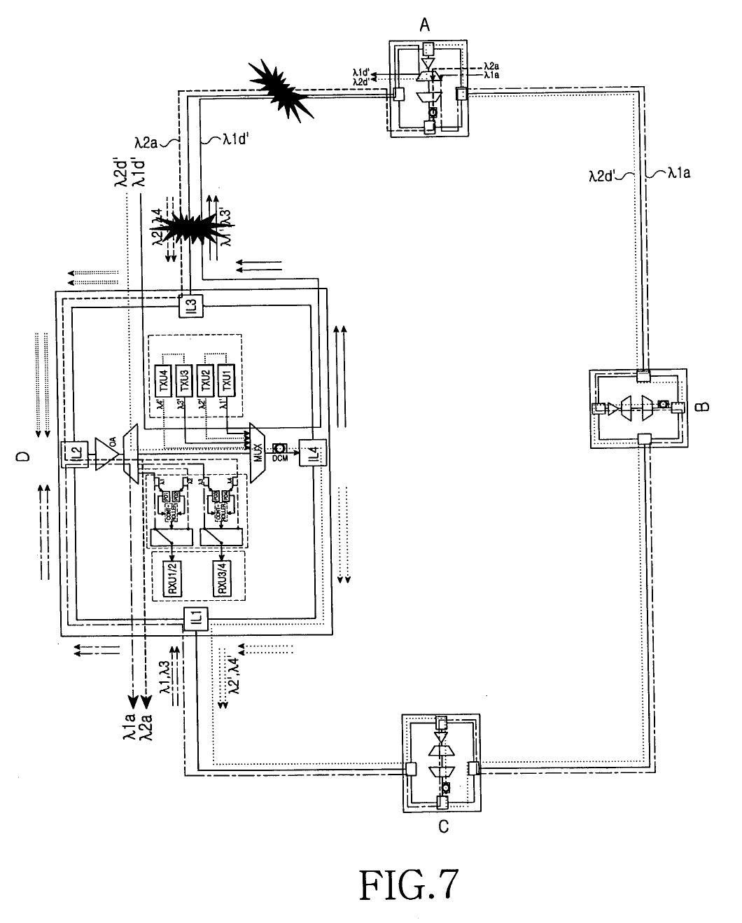

FIG. 7 shows a configuration of a bi-directional wavelength division multiplexing self-healing optical network in a failure state. This example network is implemented with four nodes using the configuration of the node shown in FIG. 4. In particular, FIG. 7 shows a configuration in which optical fiber switching is generated between nodes A and D.

Optical fiber switching generated between nodes A and D makes it impossible to transmit optical signals either from node A to node D in the counterclockwise direction or from node D to node A in the clockwise direction. Therefore, the λ1 and λ3 channels traveling in the clockwise direction in node A are transmitted to node D, while the λ2′ and λ4′ channels traveling in the counterclockwise direction in node D are transmitted to node A.

Referring now to FIGS. 4 and 7, the operation of node D will be described in regard to the above-mentioned normal state operation.

The receiving section 100 performs the same operation in an abnormal state as that in the normal state. In this regard, identical data is carried on each of the λ1′ channel of the TXU1 101, the λ2′ channel of the TXU2 102, the λ3′ channel of the TXU3 103, and the λ4′ channel of the TXU4 104. Of the channels, odd-numbered channels, the λ1′ and λ3′ channels, are transmitted in the counterclockwise direction, while even-numbered channels, the λ2′ and λ4′ channels, are transmitted in the clockwise direction. However, the even-numbered channels, including the λ2 and λ4 channels make it impossible to be input from node A to node D. The odd-numbered channels, including the λ1′ and λ3′ channels, which are added in node D, make it impossible to forward through the IL4 204 and the IL3 203 toward the node A. Therefore, the odd-numbered channels, including the λ1′ and λ3′ channels, are reflected and fed back through the IL3 203 and the IL2 202. However, because the counterclockwise path from the number 2 terminal of the IL3 203 to the number 2 terminal of the IL2 202 is one over which the even-numbered channels are transmitted, each of the odd-numbered channels, including the λ1′ and λ3′ channels, which are reflected and fed back due to the optical fiber failure or switching, is constrained by the second and third inter-leavers 202 and 203 to the level of 20 dB or more. Thus, since the reflected λ1′ and λ3′ channels have a difference of 40 dB or more in comparison with λ1 and λ3 channels, which are input from node A to node D after reflection of a maximum of 4% (14 dB), the reflected λ1′ and λ3′ channels do not act as noise. The λ1 and λ3 channels input from the node A allow their attenuated components to be amplified by the optical amplifier 205 and the first and second inter-leavers 201 and 202. The amplified λ1 and λ3 channels are separated into discrete wavelengths by the demultiplexer 206-1 of the bi-directional add/drop multiplexing unit 206, but optical signals, such as channels λ1 and λ3, which are to be transmitted at the corresponding node, are dropped. Each dropped optical signals is branched off through the 10/90 couplers 301 to 304. The photodiodes 305 to 308 sense the intensities of the branched optical signals and then transmit the sensed results to the controllers 309 and 310. Without the λ2 and λ4 channels or other optical signals, the controllers 309 and 310 cause the optical switches 311 and 312 to be switched to the failure-free λ1 and λ3 channels. Owing to the switching operation of the 1×2 optical switches 309 and 310, the λ1 and λ3 channels are input into an RXU1/2, a first receiver 401, an RXU3/4, and a second receiver 402. Newly added optical signals, i.e., the λ1′, λ2′, λ3′ and λ4′ channels, are multiplexed by the multiplexer 206-2 of the bi-directional add/drop multiplexing unit 206. The multiplexed optical signals, which generate a chromatic dispersion during high-speed transmission, are compensated by the dispersion compensating module 207, and then input into the number 1 terminal of the IL4 204. The odd-number channels are output to the number 3 terminal or the right-hand path of the IL4 and then input into the IL3 203. Even-numbered channels are output to the number 2 terminal or the left-hand path of the IL4 and then input into the IL1 201. Either the odd-numbered channels input into IL3 or the even-numbered channels input into IL1 are directed to their target node. For instance, the λ2′ and λ4′ channels, passing through nodes C and B without optical fiber switching may be received at node A.

The above-mentioned configuration enables the optical signals for transmission to be effectively transmitted through a single optical fiber without changing the optical fiber even during optical fiber switching.

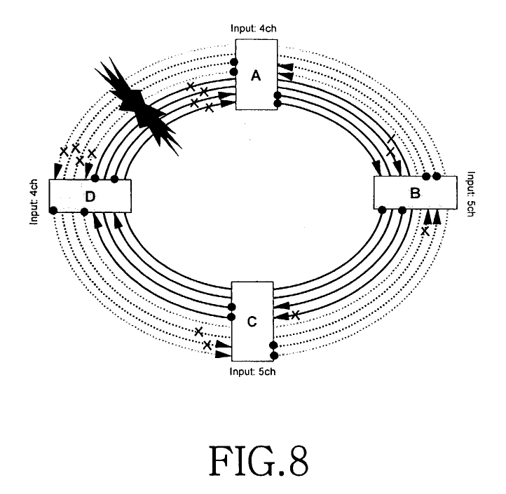

FIG. 8 is a diagram representing what when a failure takes place in a bi-directional wavelength division multiplexing self-healing optical network according to aspects of the present invention. In FIG. 8, communication is carried out with eight channels between four nodes. Dots and solid lines represent channels forwarding in a direction opposite to each other. A symbol X represents a channel that is not input into a target node. A symbol • (a large dot) represents a channel that is passing through a certain node. Finally, a symbol [symbol] (an arrow) represents a dropped channel.

In a normal state, an optical amplifier in each node is supplied with a uniform channel power with respect to all eight channels. However, when a certain optical fiber encounters a switching or a failure, four channels, half of the total existing channels, are input into two nodes A and D adjacent to the switched position, while the other nodes B and C allow for input of four or more channels. Therefore, since the optical amplifier in each node must cope with an input power level ranging from that of four channels to that of five channels, the optical amplifier has only to cope with a variable region (3 dB) belonging to half of the maximal input power, as compared with the conventional self-healing optical network.

While the above-detailed description has been made with reference to preferred embodiments of the present invention, it will be understood by those skilled in the art that various changes in form and details may be made as long as they fall within the scope of the invention. Therefore, the invention should not be limited to the preferred embodiment thereof, but be defined by the appended claims as well as by the equivalent to the claims.

As seen from the foregoing description, a bi-directional wavelength division multiplexing self-healing optical network employing one strand of optical fiber according to aspects of the present invention is capable of covering the transmission capacity of the conventional wavelength division multiplexing self-healing optical network employing two stands of optical fiber, because bi-directional optical signals are propagated through the one strand of optical fiber, which makes the optical fiber twice as available as one in the conventional self-healing optical network.

Further, a bi-directional wavelength division multiplexing self-healing optical network according to aspects of the present invention allows bi-directional optical signals to share various optical parts, such as the dispersion compensating module, the optical amplifier and so forth, in each node, so that it has an economical operation over the conventional bi-directional wavelength division multiplexing self-healing optical network.

Also, a bi-directional wavelength division multiplexing self-healing optical network according to aspects of the present invention allows bi-directional wavelengths to be inter-leavered in alternatation between other bi-directional wavelengths propagating in the same direction and then to be transmitted, so that it has good wavelength availability.

Moreover, while the conventional bi-directional wavelength division multiplexing self-healing optical network has an influence on transmission quality when optical signals reflected during optical fiber switching amount to more than 4% of the total optical signals without reflection, a bi-directional wavelength division multiplexing self-healing optical network according to aspects of the present invention has no influence on the transmission quality regardless of the reflected optical signals because reflected optical signals are sufficiently constrained by the inter-leavers.

In addition, when a failure of the optical fiber takes place, nodes adjacent to the optical fiber allow half of the channel power of a normal state to be input, so that a control range, which depends on the input power of the amplifier in each node, can be decreased.

What is claimed is:

1. A bi-directional wavelength division multiplexing self-healing optical network, in which a plurality of nodes are connected with each other through an optical fiber, each of the nodes comprising:
a transmitting section arranged to output a plurality of channels of different wavelengths and to transmit the same transmission data on a plurality of pairs of channels, each pair of channels including of an odd-numbered channel for one channel and an even-numbered channel for the other channel;
a wavelength switching bi-directional add/drop multiplexing section including a plurality inter-leavers, each of the inter-leavers being provided with a plurality terminals which a low for transmitting optical signals in at least two directions, each of the inter-leavers having a second and a third terminal connected with each other by means of one strand of optical fiber, causing the odd-numbered channels and the even-numbered channels, which the plurality of pairs of channels carrying the same transmission data are comprised of, to be forwarded in a direction opposite to each other, causing both the odd-numbered channels and the even-numbered channels forwarded in opposite directions to be forwarded in the same direction through the first terminal, and inter-leavering the odd numbered channels and the even-numbered channels forwarded in the same direction; and including an add/drop multiplexing unit arranged to demultiplex the channels in order to drop at least one, which is to be received, of the optical signals inter-leavered with the odd- and even-numbered channels by a second inter-leaver, and to multiplex at least one, which is to be transmitted, of the optical signals inter-leavered with the odd- and even-numbered channels by the second inter-leaver;
a switching section arranged to sense whether at least one optical signal for reception from among the plurality of odd- and even-numbered channel pairs which have been demultiplexed and dropped exists, and to switch at least one such sensed optical signal to at least one failure-free channel; and
a receiving section arranged to receive at least one optical signal from the switching section.

2. The bi-directional wavelength division multiplexing self-healing optical network according to claim 1, wherein the plurality of inter-leavers comprise:
a fourth inter-leaver arranged to cause the even-numbered channels among the multiplexed optical signals input from the add/drop multiplexing unit into a first terminal of the fourth inter-leaver to be output to a second terminal of the fourth inter-leaver and for causing the odd-numbered channels to be output to a third terminal of the fourth inter-leaver;
a first inter-leaver arranged to receive the even-numbered channels output to the second terminal of the fourth inter-leaver through a second terminal of the first inter-leaver, to cause the received even-numbered channels to be output through a first terminal of the first inter-leaver to an adjacent target node, and to cause the odd-numbered channels input from the adjacent target node to be outputted to a third terminal of the first inter-leaver;
a third inter-leaver arranged to receive the odd-numbered channels outputted from the third terminal of the fourth inter-leaver through a third terminal of the third inter-leaver, and to cause the received odd-numbered channels to be output through a first terminal of the third inter-leaver to an adjacent target node and to cause the even-numbered channels input from the adjacent target node to be output to a second terminal of the third inter-leaver; and
the second inter-leaver arranged to receive the odd-numbered channels output from the third terminal of the first inter-leaver through a third terminal of the second inter-leaver and the even-numbered channels output from the second terminal of the third inter-leaver through a second terminal of the second inter-leaver, to inter-leave the received odd- and even-numbered channels according to wavelengths, and to output the inter-leavered odd- and even-numbered channels to a first terminal of the second inter-leaver.

3. The bi-directional wavelength division multiplexing self-healing optical network according to claim 2, wherein the wavelength switching bi-directional add/drop multiplexing section further comprises;
an amplifier arranged to amplify optical signals inter-leavered by the second inter-leaver and to output the amplified optical signals to the add/drop multiplexing unit; and
a dispersion compensating module arranged to compensate for chromatic dispersion of optical signals multiplexed by the add/drop multiplexing unit and to output the compensated optical signals to the first terminal of the fourth inter-leaver.

4. The bi-directional wavelength division multiplexing self-healing optical network according to claim 1, wherein the odd- and even-numbered channel of each pair are adjacent to each other.

5. The bi-directional wavelength division multiplexing self-healing optical network according to claim 1, wherein the switching section comprises:
a plurality of optical coupler pairs arranged to cause each odd- and even-numbered channel of the pairs of signals which are demultiplexed and dropped to branch off;
a plurality of photodiode pairs arranged to sense intensities of the branched optical signals;
a plurality of optical switches arranged to switch connections of the odd- and even-numbered channel pairs according to whether at least one optical signal to be received exists; and
a plurality of controllers arranged to check whether at least one optical signal to be received exists according to intensities of optical signals sensed by the photodiode pairs and controlling the optical switches.

6. The bi-directional wavelength division multiplexing self-healing optical network according to claim 1, wherein each of the optical switches is a 1×2 optical switch.

7. A node for a bi-directional wavelength division multiplexing self-healing optical network, the nodes comprising:
a transmitting section arranged to output a plurality of channels of different wavelengths and to transmit the same transmission data on a plurality of pairs of channels, each pair of channels including of an odd-numbered channel for one channel and an even-numbered channel for the other channel;
a wavelength switching bi-directional add/drop multiplexing section including a plurality inter-leavers, each of the inter-leavers being provided with a plurality terminals which allow for transmitting optical signals in at least two directions, each of the inter-leavers having a second and a third terminal connected with each other by means of one strand of optical fiber, causing the odd-numbered channels and the even-numbered channels, which the plurality of pairs of channels carrying the same transmission data are comprised of, to be forwarded in a direction opposite to each other, causing both the odd-numbered channels and the even-numbered channels forwarded in opposite directions to be forwarded in the same direction through the first terminal, and inter-leavering the odd numbered channels and the even-numbered channels forwarded in the same direction; and including an add/drop multiplexing unit arranged to demultiplex the channels in order to drop at least one, which is to be received, of the optical signals inter-leavered with the odd- and even-numbered channels by a second inter-leaver, and to multiplex at least one, which is to be transmitted, of the optical signals inter-leavered with the odd- and even-numbered channels by the second inter-leaver;
a switching section arranged to sense whether at least one optical signal for reception from among the plurality of odd- and even-numbered channel pairs which have been demultiplexed and dropped exists, and to switch at least one such sensed optical signal to at least one failure-free channel; and
a receiving section arranged to receive at least one optical signal from the switching section.

8. The node according to claim 7, wherein the plurality of inter-leavers comprise:
a fourth inter-leaver arranged to cause the even-numbered channels among the multiplexed optical signals input from the add/drop multiplexing unit into a first terminal of the fourth inter-leaver to be output to a second terminal of the fourth inter-leaver and for causing the odd-numbered channels to be output to a third terminal of the fourth inter-leaver;
a first inter-leaver arranged to receive the even-numbered channels output to the second terminal of the fourth inter-leaver through a second terminal of the first inter-leaver, to cause the received even-numbered channels to be output through a first terminal of the first inter-leaver to an adjacent target node, and to cause the odd-numbered channels input from the adjacent target node to be outputted to a third terminal of the first inter-leaver;
a third inter-leaver arranged to receive the odd-numbered channels outputted from the third terminal of the fourth inter-leaver through a third terminal of the third inter-leaver, and to cause the received odd-numbered channels to be output through a first terminal of the third inter-leaver to an adjacent target node and to cause the even-numbered channels input from the adjacent target node to be output to a second terminal of the third inter-leaver; and
the second inter-leaver arranged to receive the odd-numbered channels output from the third terminal of the first inter-leaver through a third terminal of the second inter-leaver and the even-numbered channels output from the second terminal of the third inter-leaver through a second terminal of the second inter-leaver, to inter-leave the received odd- and even-numbered channels according to wavelengths, and to output the inter-leavered odd- and even-numbered channels to a first terminal of the second inter-leaver.

9. The node according to claim 8, wherein the wavelength switching bi-directional add/drop multiplexing section further comprises;
an amplifier arranged to amplify optical signals inter-leavered by the second inter-leaver and to output the amplified optical signals to the add/drop multiplexing unit; and
a dispersion compensating module arranged to compensate for chromatic dispersion of optical signals multiplexed by the add/drop multiplexing unit and to output the compensated optical signals to the first terminal of the fourth inter-leaver.

10. The node according to claim 7, wherein the odd- and even-numbered channel of each pair are adjacent to each other.

11. The node according to claim 7, wherein the switching section comprises:
a plurality of optical coupler pairs arranged to cause each odd- and even-numbered channel of the pairs of signals which are demultiplexed and dropped to branch off;
a plurality of photodiode pairs arranged to sense intensities of the branched optical signals;
a plurality of optical switches arranged to switch connections of the odd- and even-numbered channel pairs according to whether at least one optical signal to be received exists; and
a plurality of controllers arranged to check whether at least one optical signal to be received exists according to intensities of optical signals sensed by the photodiode pairs and controlling the optical switches.

12. The node according to claim 1, wherein each of the optical switches is a 1×2 optical switch.

13. A method of transmitting data in a bi-directional wavelength division multiplexing self-healing optical network, in which a plurality of nodes are connected with each other through an optical fiber, the method comprising the step of:
outputting a plurality of channels, from a first node, of different wavelengths so that the same transmission data is transmitted on a plurality of pairs of channels, each pair of channels including of an odd-numbered channel for one channel and an even-numbered channel for the other channel; transmitting optical signals in two directions to that the odd-numbered channels and the even-numbered channels, which the plurality of pairs of channels carrying the same transmission data are comprised of are forwarded in a direction opposite to each other, and causing both the odd-numbered channels and the even-numbered channels forwarded in opposite directions to be forwarded in the same direction through the first terminal;
inter-leavering, via a plurality of inter-leavers, the odd numbered channels and the even-numbered channels forwarded in the same direction;
dropping at least one, which is to be received, of the optical signals inter-leavered with the odd- and even-numbered channels by an inter-leaver, and multiplexing at least one, which is to be transmitted, of the optical signals inter-leavered with the odd- and even-numbered channels by the second inter-leaver;
sensing whether at least one optical signal for reception from among a plurality of odd- and even-numbered channel pairs which have been demultiplexed and dropped exists;
switching at least one such sensed optical signal to at least one failure-free channel; and
receiving at least one optical signal from said switching step.

14. The method according to claim 13, wherein the odd- and even-numbered channel of each pair are adjacent to each other.
